(19) United States
(12) Patent Application Publication
(10) Pub. No.: US 2026/0017087 A1
(43) Pub. Date: Jan. 15, 2026

(54) AUTOMATED TASK GENERATION AND EXECUTION USING ARTIFICIAL INTELLIGENCE-BASED DATA STRUCTURE PROCESSING

(71) Applicant: Dell Products L.P., Round Rock, TX (US)

(72) Inventors: Wai Teck Goh, Cyberjaya (MY); Say Heian Lee, Cyberjaya (MY); Karman Yap, Cheras (MY); Kah Wai Kor, Bukit Jalil (MY)

(21) Appl. No.: 18/771,138

(22) Filed: Jul. 12, 2024

(51) Int. Cl. G06F 9/48; G06F 16/2457

(52) U.S. Cl. CPC G06F 9/4843; G06F 16/24575

(57) ABSTRACT

Methods, apparatus, and processor-readable storage media for automated task generation and execution using artificial intelligence-based data structure processing are provided herein. An example computer-implemented method includes obtaining a user query related to executing at least one system task in connection with one or more user-provided system task parameters; determining contextual information pertaining to the at least one system task by processing at least portions of one or more task-related data structures using a set of one or more artificial intelligence techniques; validating the one or more user-provided system task parameters by processing the user query and at least a portion of the determined contextual information; generating instructions for executing the at least one system task based at least in part on the validating of the one or more user-provided system task parameters; and initiating automated execution of the at least one system task based on the generated instructions.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

In connection with many computing systems, numerous tasks are commonly required to be implemented and/or carried out to further various objectives. However, conventional system management approaches typically rely on and/or require manual efforts which are often error-prone, resource-intensive, and contribute to latencies.

### SUMMARY

Illustrative embodiments of the disclosure provide techniques for automated task generation and execution using artificial intelligence-based data structure processing.

An exemplary computer-implemented method includes obtaining a user query related to executing at least one system task in connection with one or more user-provided system task parameters, and determining contextual information pertaining to the at least one system task by processing at least portions of one or more task-related data structures using a set of one or more artificial intelligence techniques. The method also includes validating the one or more user-provided system task parameters by processing the user query and at least a portion of the determined contextual information, and generating instructions for executing the at least one system task based at least in part on the validating of the one or more user-provided system task parameters. Additionally, the method includes initiating automated execution of the at least one system task based at least in part on the generated instructions.

Illustrative embodiments can provide significant advantages relative to conventional system management approaches. For example, problems associated with error-prone and resource-intensive manual efforts which contribute to latencies are overcome in one or more embodiments through automatically creating enhanced task execution instructions and automatically initiating execution of the corresponding task.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automated task generation and execution using artificial intelligence-based data structure processing in an illustrative embodiment.

FIG. 2 shows an example workflow for processing a user query in an illustrative embodiment.

FIG. 3 shows an example communication between a generative artificial intelligence-based task controller and a database engineer in an illustrative embodiment.

FIG. 4 shows an example workflow for processing a user query in an illustrative embodiment.

FIG. 5 shows example pseudocode for implementing retrieval-augmented generation (RAG) techniques with at least one large language model (LLM) in an illustrative embodiment.

FIG. 6 shows example task parameter validation logic in an illustrative embodiment.

FIG. 7 shows example pseudocode for task parameter validation in an illustrative embodiment.

FIG. 8 shows example pseudocode for implementing rule-based logic in connection with task intelligence in an illustrative embodiment.

FIG. 9 shows example pseudocode for implementing hypertext transfer protocol secure (HTTPS) application programming interface (API) services in connection with a task intelligence component in an illustrative embodiment.

FIG. 10 shows an example task generation engine workflow in an illustrative embodiment.

FIG. 11 shows example pseudocode for implementing a task generation engine workflow in an illustrative embodiment.

FIG. 12 shows an example workflow involving a task execution engine and a task generation engine in an illustrative embodiment.

FIG. 13 shows example pseudocode for implementing JavaScript object notation (JSON) data used in connection with a task execution engine in an illustrative embodiment.

FIG. 14 shows example input, output, and a corresponding generative artificial intelligence-based task controller workflow in an illustrative embodiment.

FIG. 15 is a flow diagram of a process for automated task generation and execution using artificial intelligence-based data structure processing in an illustrative embodiment.

FIGS. 16 and 17 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

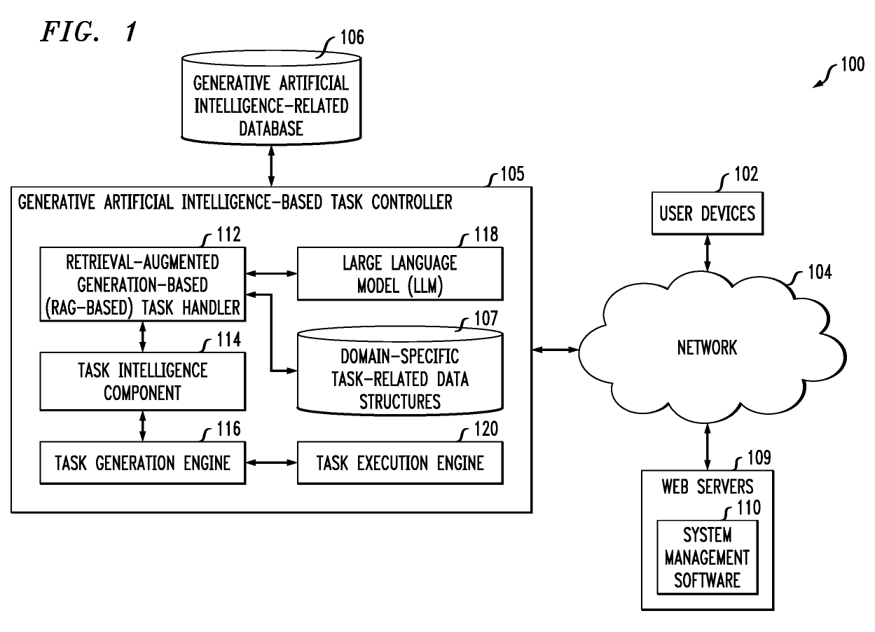

FIG. 1 shows a computer network (also referred to herein as an information processing system) 100 configured in accordance with an illustrative embodiment. The computer network 100 comprises one or more user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is generative artificial intelligence-based task controller 105 and system management software 110 (e.g., at least one database management system (DBMS)) executing on one or more web servers 109.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the generative artificial intelligence-based task controller 105 can have an associated generative artificial intelligence-related database 106 configured to store data pertaining to tasks such as, e.g., unique transaction identifiers representing task requests, task requests supplemented with context-related information, etc. Also, as depicted in FIG. 1, the generative artificial intelligence-based task controller 105 can have one or more domain-specific task-related data structures 107 configured to store domain-specific data pertaining to tasks such as required task parameter data, task execution status updates, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The generative artificial intelligence-related database 106 and/or domain-specific task-related data structures 107 in the present embodiment is implemented using one or more storage systems associated with the generative artificial intelligence-based task controller 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the generative artificial intelligence-based task controller 105 are one or more input-output devices, which illustratively comprise keyboards, displays or other types of input-output devices in any combination. Such input-output devices can be used, for example, to support one or more user interfaces to the generative artificial intelligence-based task controller 105, as well as to support communication between the generative artificial intelligence-based task controller 105 and other related systems and devices not explicitly shown.

Additionally, the generative artificial intelligence-based task controller 105 in the FIG. 1 embodiment is assumed to be implemented using at least one processing device. Each such processing device generally comprises at least one processor and an associated memory, and implements one or more functional modules for controlling certain features of the generative artificial intelligence-based task controller 105.

More particularly, the generative artificial intelligence-based task controller 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the generative artificial intelligence-based task controller 105 to communicate over the network 104 with the user devices 102, and illustratively comprises one or more conventional transceivers.

The generative artificial intelligence-based task controller 105 further comprises a RAG-based task handler 112, a task intelligence component 114, a task generation engine 116, at least one LLM 118, and a task execution engine 120.

It is to be appreciated that this particular arrangement of elements 112, 114, 116, 118 and 120 illustrated in the generative artificial intelligence-based task controller 105 of the FIG. 1 embodiment is presented by way of example only, and alternative arrangements can be used in other embodiments. For example, the functionality associated with elements 112, 114, 116, 118 and 120 in other embodiments can be combined into a single module, or separated across a larger number of modules. As another example, multiple distinct processors can be used to implement different ones of elements 112, 114, 116, 118 and 120 or portions thereof.

At least portions of elements 112, 114, 116, 118 and 120 may be implemented at least in part in the form of software that is stored in memory and executed by a processor.

It is to be understood that the particular set of elements shown in FIG. 1 for automated task generation and execution using artificial intelligence-based data structure processing involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of generative artificial intelligence-based task controller 105, generative artificial intelligence-related database 106, domain-specific task-related data structures 107, and web servers 109 can be on and/or part of the same processing platform.

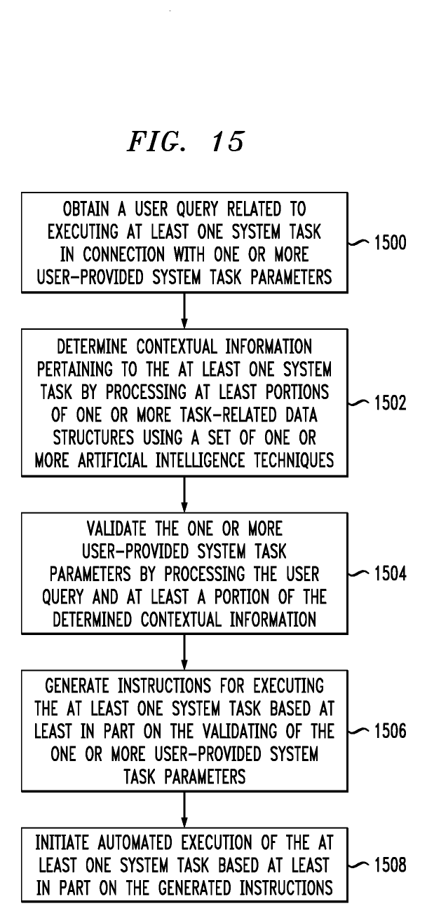

An exemplary process utilizing elements 112, 114, 116, 118 and 120 of an example generative artificial intelligence-based task controller 105 in computer network 100 will be described in more detail with reference to the flow diagram of FIG. 15.

Accordingly, at least one embodiment includes automated task generation and execution using artificial intelligence-based data structure processing. By way merely of example, in accordance with such an embodiment, one or more database tasks can be created and executed by using RAG techniques, a rule-based task intelligence component, a task execution engine, and an LLM. By way merely of example, an LLM used in one or more embodiments can include at least one generative pre-trained transformer (GPT) such as, e.g., GPT-4, and/or at least one autoregressive LLM (e.g., Llama). Also, in one or more embodiments, RAG techniques can include, for example, chunking techniques wherein external data from a vector database (e.g., domain-specific task-related data structures 107) is transformed into a numeric vector using an embedding model. Additionally, at least one index can be built to store these chunks and their embeddings. Such RAG techniques can be implemented, for example, to improve the accuracy of the LLM response(s).

Also, it should be appreciated that one or more example embodiments described herein pertain to a database and/or database task context, but such embodiments serve merely as examples and other embodiments can be implemented in connection with other contexts and/or use cases.

By way merely of example, consider a scenario wherein a database engineer wants to request a database task such as a database provisioning task. In accordance with one or more embodiments such as depicted, e.g., in FIG. 1, the database engineer can input the required parameters for the database provisioning task in connection with a prompt. Such input data can be sent to and/or processed by generative artificial intelligence-based task controller 105. More particularly, RAG-based task handler 112 can process at least a portion of the input data for keywords, tasks, and/or parameter detection using at least RAG workflow in connection with domain-specific task-related data structures 107. The domain-specific task-related data structures 107 store, among other data, database task domain knowledge and can be a knowledge source for task detection.

After such context information is retrieved, the input data (e.g., the query) and the retrieved context information are sent to and/or processed by LLM 118 to generate at least one response. The content of the response from LLM 118 can include, for example, task details with parameters, task validation information, and approval of the task. By way merely of illustration, an example LLM response can include the following: “The provision task is valid, and the parameters matched the expectation of the execution task; Approved: Task Details Provision a new database task – template 12; Task Parameters Database Type, Storage Size, Licensing, Data Center, and Database Name.”

Upon the confirmation of the response from the user (e.g., the database engineer) via user device 102, the generative artificial intelligence-based task controller 105 validates the task parameters, executes the database task, and obtains at least one corresponding response from system management software 110 (e.g., a DBMS). The response from system management software 110 can then be uploaded to and/or stored in domain-specific task-related data structures 107 for the user (e.g., the database engineer) to monitor the status of the task via the LLM 118. By way of example, LLM 118 can learn about the status of the task with the help of the response from task intelligence component 114, and LLM 118 can then update the status of the task to domain-specific task-related data structures 107. Additionally, final responses from LLM 118 and system management software 110 (e.g., regarding completion of the task) can be merged to create a dynamic response to the user (e.g., the database engineer).

Referring again to FIG. 1, one or more embodiments include using RAG-based task handler 112, which processes user queries using one or more RAG workflows, in conjunction with LLM 118, to generate accurate responses that confirm the task requests from the user queries are appropriate and the corresponding task parameters are correct. Once the task parameters are determined to be correct, the query and corresponding input data will be sent to task intelligence component 114 for validation. Additionally, as detailed herein, RAG-based task handler 112 can retrieve response details from system management software 110 (e.g., a DBMS) via task execution engine 120, and update at least a portion of domain-specific task-related data structures 107 with status updates of task execution.

Also, as noted above, task intelligence component 114 validates task parameters and/or details. In at least one embodiment, each task parameter can be verified using automated business logic to ensure that the task is appropriate and/or acceptable to execute when all the pre-execution conditions are met and/or satisfied. If a parameter validation fails, task intelligence component 114 will search for at least one alternative based at least in part on preconfigured rule-based intelligence.

Additionally, in one or more embodiments, when task generation engine 116 receives a task from task intelligence component 114, task generation engine 116 selects a task automation template corresponding to the query task and ensures that the task is ready for execution. In such an embodiment, the task can be designated to a “ready’ state only when the task execution template is located, task parameters are validated, and the remote host is ready and online. Also, task execution engine 120 receives the task instruction(s) from task generation engine 116 and initiates task execution, for example, by making a request to system management software 110 (e.g., a DBMS) for task execution. Task execution engine 120 also ensures that the task status is updated to the task generation engine 116, which can then send updates and/or related notifications to task intelligence component 114 and/or RAG-based task handler 112.

When the user (e.g., via user device 102) interacts with generative artificial intelligence-based task controller 105 with task execution capability, the generative artificial intelligence-based task controller 105 is capable of executing a task based on the provided inputs. As part of processing such inputs, the generative artificial intelligence-based task controller 105 detects keywords such as, e.g., task name and required parameters that have been vectorized in one or more domain-specific task-related data structures 107.

As also detailed herein, before a task is created, the task parameters need to be validated. For example, when a new database is requested, the generative artificial intelligence-based task controller 105 ensures that the needed data center capacity is available. When all conditions are fulfilled, the task will be created. Upon task completion, the user receives a notification and/or update about the status of the task. For example, a response from system management software 110 can be uploaded to the RAG-based task handler 112 for monitoring (e.g., by the user) the status of the task.

Accordingly, and as further detailed herein, one or more embodiments include leveraging generative artificial intelligence techniques in connection with task execution capability. Such an embodiment enables users to create and execute tasks via input prompts. Also, as used herein, generative artificial intelligence techniques refer to a class of artificial intelligence algorithms and/or models that are designed to generate new content, data, and/or information.

For example, once a user query is received, the RAG-based task handler 112 retrieves the relevant information (e.g., task details and/or requirements) from one or more domain-specific task-related data structures 107. Such relevant information can include, for example, task name and required task parameters. The relevant information and the user query are sent to and/or processed by LLM 118 for generating a response (to the user query) which can be stored and utilized for subsequent responses with status updates from one or more other elements of generative artificial intelligence-based task controller 105. Once the relevant information (e.g., task name and required task parameters) are received and/or determined, the task intelligence component 114 starts validation of the task parameters. Once the task parameters are successfully validated, the task-related requirements are passed to and/or processed by the task generation engine 116 for task creation.

Accordingly, a function of the task generation engine 116 is to create the actual task instructions by selecting the correct automation template (stored, e.g., in domain-specific task-related data structures 107) and calling the task execution engine 120 for task execution. When the task execution engine 120 receives the task request, the task execution engine 120 will log the execution status to the domain-specific task-related data structures 107, initiate execution of the task by calling the system management software 110 for executing the task, and obtain and/or process the response(s) from the system management software 110. Once the task execution status is received, the response will be sent back to the RAG-based task handler 112 for adding the task status to the domain-specific task-related data structures 107. Such dynamic data will be added to the domain-specific task-related data structures 107 for monitoring task-related information. As such, the RAG-based task handler 112 can retrieve such information, add the latest information to the domain-specific task-related data structures 107, and respond to the user in connection therewith. The user response can be generated using LLM 118, and the response can include, e.g., the latest task-related information and/or execution status.

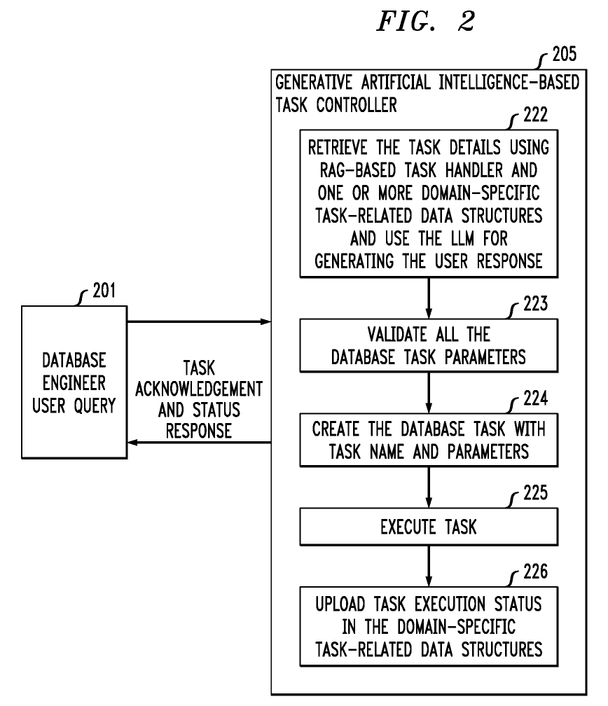

FIG. 2 shows an example workflow for processing a user query in an illustrative embodiment. By way of illustration, FIG. 2 depicts a database engineer user query 201 being provided to and/or processed by generative artificial intelligence-based task controller 205. More particularly, within generative artificial intelligence-based task controller 205, a RAG-based task handler, in step 222, uses the user query to retrieve the relevant information from one or more domain-specific task-related data structures about the request task details. Once the retrieval is completed, step 222 also includes the user query and retrieved relevant information are sent to an LLM for generating a response about the task. The RAG-based task handler forwards the task request and generated response to a task intelligence component for task parameter validation in step 223.

When the task parameters are validated, the request is sent to a task generation engine in step 224 for task creation (e.g., creating task execution instructions). A task execution engine, in step 225, initiates execution of the task by sending the task request and execution instructions (received from the task generate engine) to system management software associated with the request. Upon task execution, the task execution engine, in step 226, obtains an acknowledgement and task status reply, and forwards the reply back to the task handler for upload and/or storing in the domain-specific task-related data structures. Accordingly, the task handler can initiate a corresponding user response (to the original user query) with the LLM generating the response for a task detail reply.

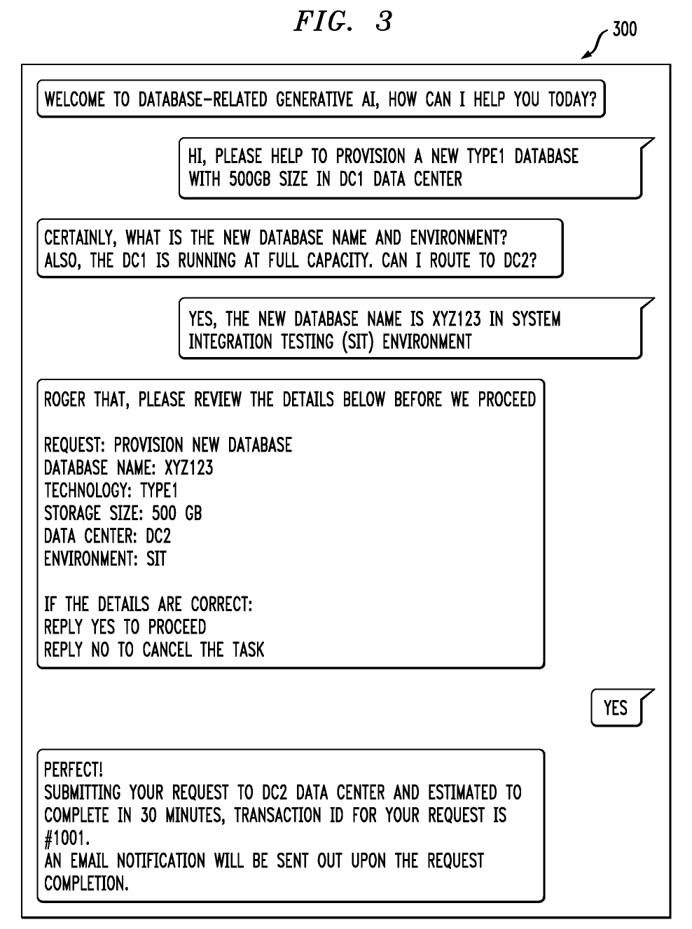

FIG. 3 shows an example communication 300 between a generative artificial intelligence-based task controller (e.g., element 105 in FIG. 1) and a database engineer in an illustrative embodiment. In the example communication 300, the database engineer is requesting a new database and provides the parameters that are needed for database provisioning. Once the generative artificial intelligence-based task controller processes the request (e.g., using an LLM) and validates the parameters, the generative artificial intelligence-based task controller starts a new database provisioning task. Accordingly, before processing and/or submitting the task request, all of the provided parameter conditions need to be fulfilled. For instance, in at least one embodiment, the generative artificial intelligence-based task controller has the ability to validate that the data center in question is running at full capacity, as shown in the example communication 300. If the data center is running at full capacity, the generative artificial intelligence-based task controller can suggest another data center for database provisioning. Once the database engineer confirms the suggestion, the generative artificial intelligence-based task controller can start the task and obtain the task details for the user (e.g., the database engineer) to monitor the progress of the provisioning task. Additionally, in such an example embodiment as depicted in FIG. 3, the task details can be derived and/or obtained from a corresponding DBMS.

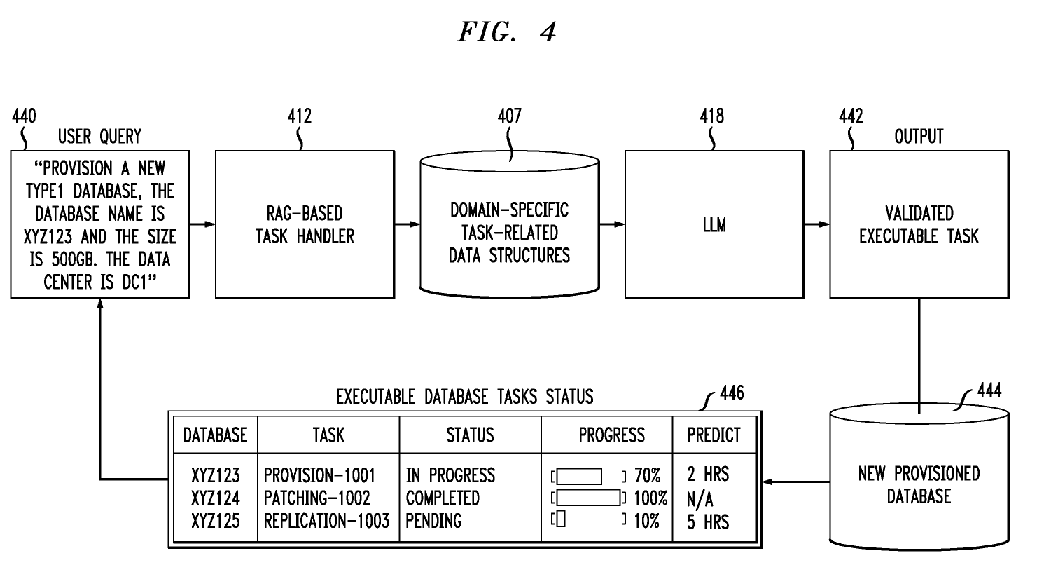

FIG. 4 shows an example workflow for processing a user query in an illustrative embodiment. By way of illustration, FIG. 4 depicts a user query 440 which requests provisioning of a new Type1 database, the database name being XYZ123, the size is 500GB, and the data center being DC1. A function of a RAG-based task handler 412 is to use the user query 440 to retrieve task-related information from domain-specific task-related data structures 407. If the task is available, retrieved context information from domain-specific task-related data structures 407 and the user query 440 are sent to LLM 418. Otherwise, the RAG-based task handler 412 informs the user that the task is unavailable. Once the task is confirmed, the task name and the required parameters are sent for validation by a task intelligence component. If the task parameter validation fails, a task rejection is sent to the user.

Accordingly, RAG-based techniques, used with one or more LLMs, can enhance prediction quality by using domain-specific task-related data structures at inference time to build richer prompts that include context, history, and/or recent and/or relevant knowledge.

FIG. 4 illustrates RAG-based task handler 412 which retrieves information and provides such information into an LLM for text generation. Firstly, the RAG-based task handler 412 converts user query 440 into a compatible format to perform a relevancy search. To make the formats compatible, user query 440 can be converted to numerical representations using one or more embedding language models. Embedding is the process by which text is given numerical representation in a vector space. RAG model architectures compare the embeddings of user queries within domain-specific task-related data structures 407. The original user query 440 is then appended with the relevant context from similar documents within the domain-specific task-related data structures 407, and processed by LLM 418 to generate a more accurate and/or contextually aware response.

The response is then sent for validation to a task intelligence component, which outputs a validated executable task 442. The validated executable task 442 can then be executed by a task execution engine to provision a new database 444. In connection with execution of the task, a table of executable database task status information 446 can be generated and/or updated and provided to the user.

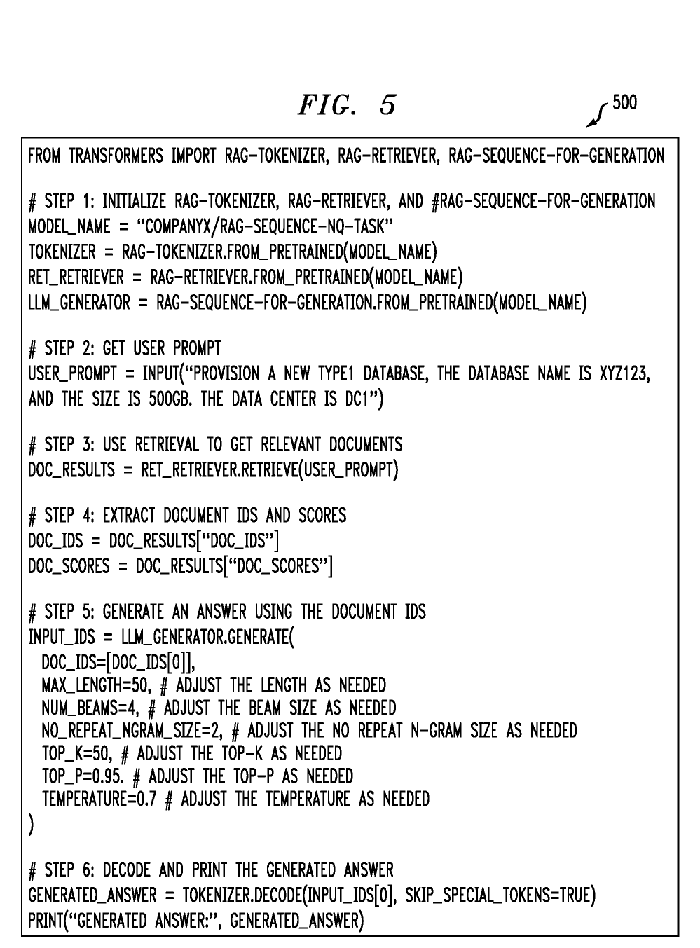

FIG. 5 shows example pseudocode for implementing RAG techniques with at least one LLM in an illustrative embodiment. In this embodiment, example pseudocode 500 is executed by or under the control of at least one processing system and/or device. For example, the example pseudocode 500 may be viewed as comprising a portion of a software implementation of at least part of generative artificial intelligence-based task controller 105 of the FIG. 1 embodiment.

The example pseudocode 500 illustrates using a RAG workflow with an LLM to generate a relevant response for a database engineer query. More particularly, example pseudocode 500 depicts a first step which includes initializing a RAG tokenizer, a RAG retriever, and a RAG sequence generator. Also, example pseudocode 500 depicts a second step which includes obtaining a user prompt (such as, e.g., a database engineer query), and a third step which includes retrieving the relevant documents (e.g., documents relevant to the user prompt). Additionally, example pseudocode 500 depicts a fourth step which includes extracting document identifiers (IDs) and scores, a fifth step which includes generating an answer using the document IDs, and a sixth step which includes decoding and printing the generated answer. Also, in example pseudocode 500, a # symbol denotes a comment.

It is to be appreciated that this particular example pseudocode shows just one example implementation of RAG techniques with at least one LLM, and alternative implementations can be used in other embodiments.

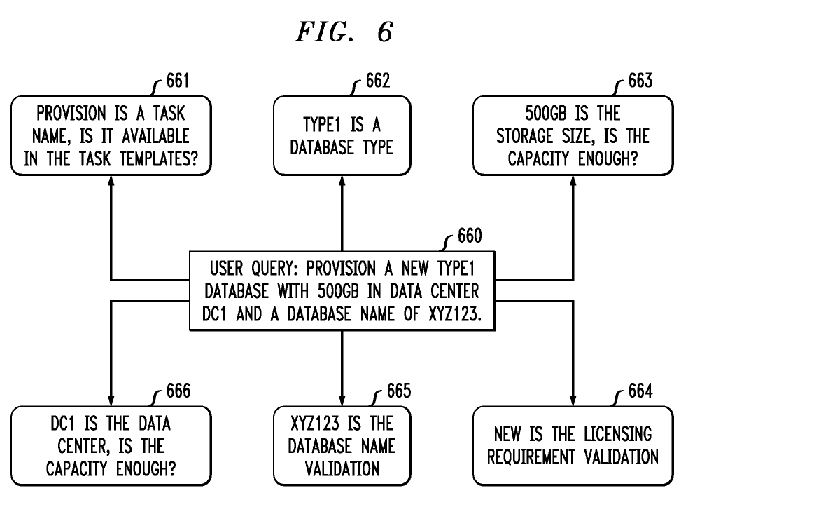

FIG. 6 shows example task parameter validation logic in an illustrative embodiment. By way of illustration, a function of a task intelligence component (e.g., element 114 in FIG. 1) is to validate task parameters using a validation logic as shown in FIG. 6. The example validation logic depicted in FIG. 6 can be implemented in connection with user query 660, which includes the follows: “Provision a new Type1 database with 500GB in data center DC1 and a database name of XYZ123.” Accordingly, the example validation logic includes logic item 661, which details that “Provision” is the task name, and asks if this task is available in the task templates. Also, logic item 662 details that “Type1” is the database type, and logic item 663 details that “500GB” is the storage size, while also asking if the capacity is enough (e.g., ensuring that the disk space in the data center meets the requested data volume). Logic item 664 details that “new” is the licensing requirement validation, logic item 665 details that “XYZ123” is the database name validation, and logic item 666 details that “DC1” is the data center, while asking if the capacity is enough (e.g., ensuring that the data center has the CPU, memory, and storage capacity to allow creation of a new database instance).

In one or more embodiments, once all task parameters are validated, the task request will be sent to a task generation engine for task creation. If at least a portion of the task parameter validation fails, the task request from a task handler will be rejected and a different and/or more appropriate solution will be suggested. For instance, if the data center capacity is not available, a response can include suggesting the use of an alternative data center for provisioning after the alternative data center capacity is checked. The response can also be added to the LLM response via the task handler prior to outputting to the user in question (e.g., the database engineer who submitted the original task request).

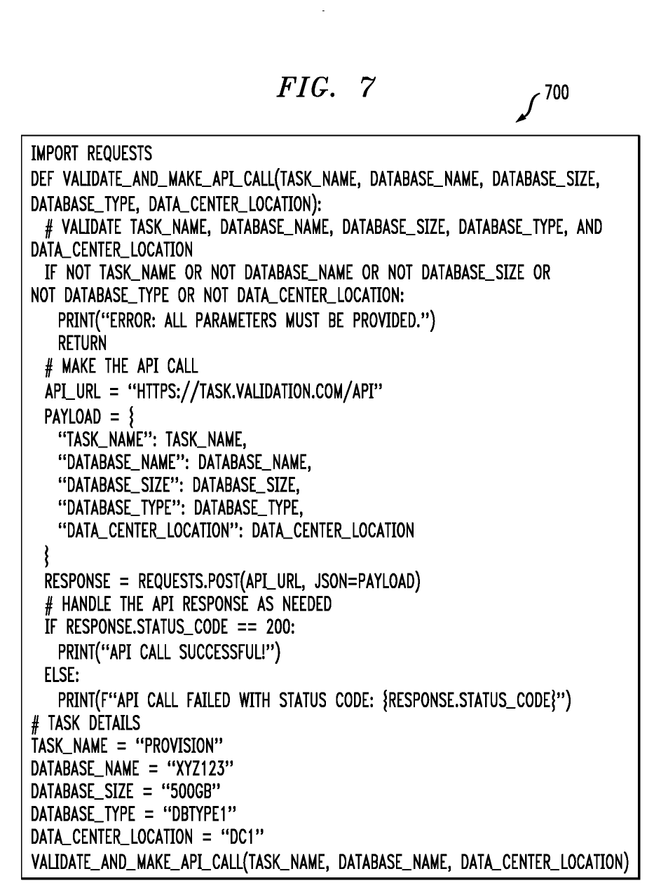

FIG. 7 shows example pseudocode for task parameter validation in an illustrative embodiment. In this embodiment, example pseudocode 700 is executed by or under the control of at least one processing system and/or device. For example, the example pseudocode 700 may be viewed as comprising a portion of a software implementation of at least part of generative artificial intelligence-based task controller 105 of the FIG. 1 embodiment.

The example pseudocode 700 illustrates steps for validating task parameters. More particularly, each parameter is sent to a validation API endpoint verification. If a given parameter is not meeting a corresponding requirement, the API endpoint returns a response with a status code. From that, a task intelligence component (e.g., element 114 in FIG. 1) can return the response back to a task handler (e.g., element 112 in FIG. 1) to inform the user of the validation result. If the task parameters are validated, the task will be sent to a task generation engine (e.g., element 116 in FIG. 1) for task creation. If one of the parameters fails the validation, the task intelligence component can search for an alternative way of replacing the parameter with rule-based logic. For instance, if the given data center (e.g., dc1) is not available, another data center (e.g., dc2) will be suggested based on given rule-based logic to advise the user (e.g., the database engineer). Also, in example pseudocode 700, a # symbol denotes a comment.

It is to be appreciated that this particular example pseudocode shows just one example implementation of task parameter validation, and alternative implementations can be used in other embodiments.

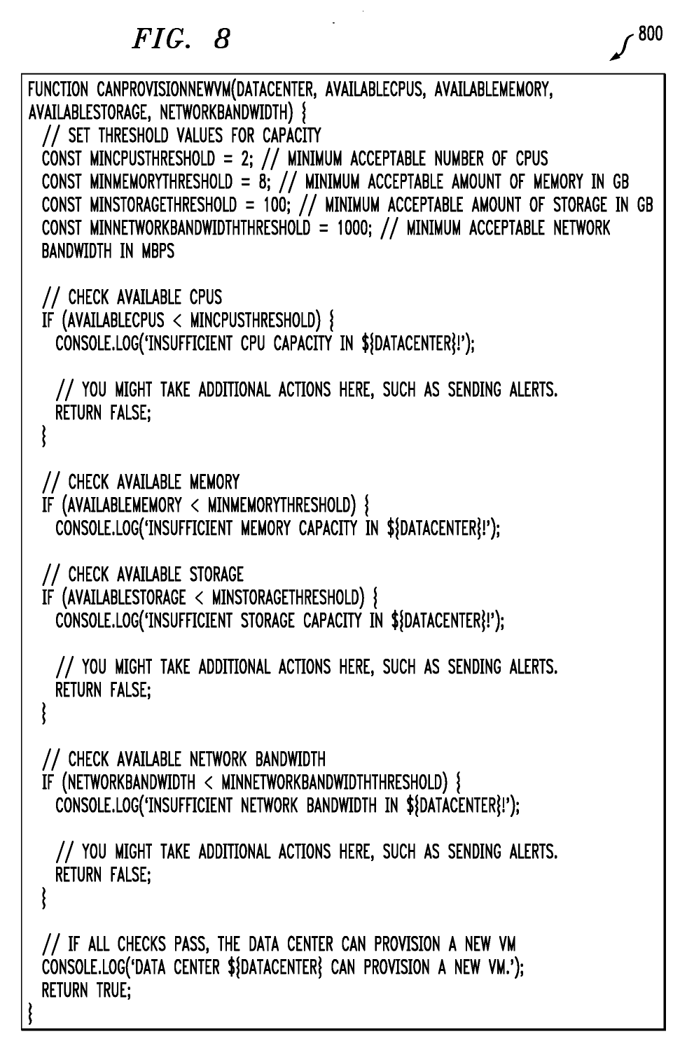

FIG. 8 shows example pseudocode for implementing rule-based logic in connection with task intelligence in an illustrative embodiment. In this embodiment, example pseudocode 800 is executed by or under the control of at least one processing system and/or device. For example, the example pseudocode 800 may be viewed as comprising a portion of a software implementation of at least part of generative artificial intelligence-based task controller 105 of the FIG. 1 embodiment.

The example pseudocode 800 illustrates determining data center capacity for a given data center (e.g., DC1). If the capacity condition is not met, example pseudocode 800 depicts checking capacity for another data center (e.g., DC2). If the capacity condition of the other data center (e.g., DC2) is met, the suggestion will be brought forward to a task handler (e.g., element 112 in FIG. 1) to be part of an LLM response to the user (e.g., a database engineer) for recommendation of use of the other data center. Also, in example pseudocode 800, a // symbol denotes a comment.

It is to be appreciated that this particular example pseudocode shows just one example implementation of rule-based logic in connection with task intelligence, and alternative implementations can be used in other embodiments.

FIG. 9 shows example pseudocode for implementing HTTPS API services in connection with a task intelligence component in an illustrative embodiment. In this embodiment, example pseudocode 900 is executed by or under the control of at least one processing system and/or device. For example, the example pseudocode 900 may be viewed as comprising a portion of a software implementation of at least part of generative artificial intelligence-based task controller 105 of the FIG. 1 embodiment.

The example pseudocode 900 illustrates an example HTTPS API service provided by a task intelligence component (e.g., element 114 in FIG. 1), wherein the primary service consumer will be a task handler (e.g., element 112 in FIG. 1) for validating task details.

It is to be appreciated that this particular example pseudocode shows just one example implementation of HTTPS API services in connection with a task intelligence component, and alternative implementations can be used in other embodiments.

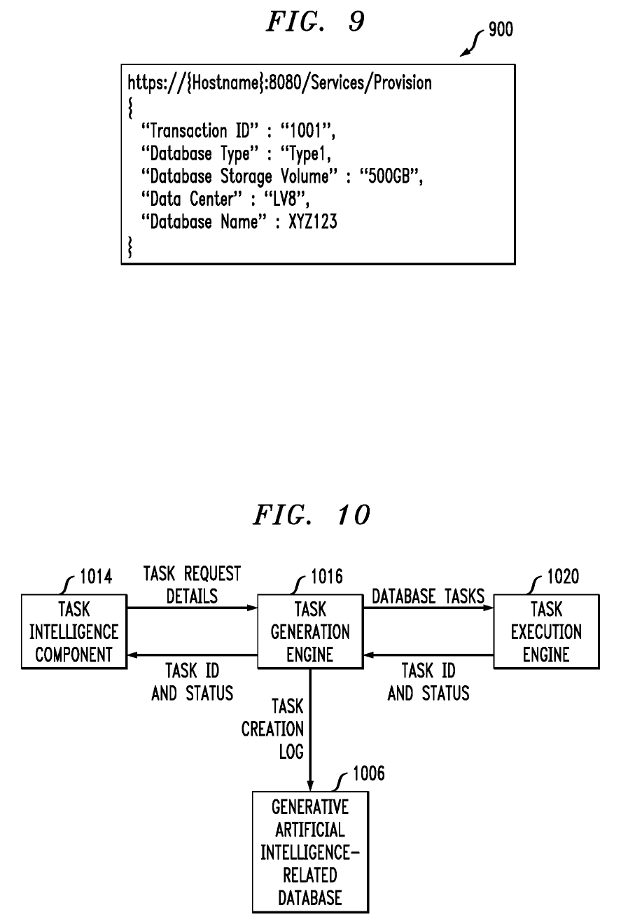

FIG. 10 shows an example task generation engine workflow in an illustrative embodiment. By way of illustration, FIG. 10 depicts task generation engine 1016 serving as an intermediary between task intelligence component 1014 and task execution engine 1020, transmitting a task request from the task intelligence component 1014 to the task execution engine 1020 to execute a database task in connection with a given DBMS. Additionally, as depicted in FIG. 10, task generation engine 1016 also establishes connections between database tasks executed by the task execution engine 1020 and the task requests from the task intelligence component 1014, storing this relational information in generative artificial intelligence-related database 1006.

Upon receiving the task request details from task intelligence component 1014, task generation engine 1016 will forward the task parameters to task execution engine 1020 via an HTTP API call for task execution on a database level. Each HTTP API call from task generation engine 1016 to task execution engine 1020 will be responded to with a task status and a task ID as an acknowledgment that the task execution order has been received and executed by task execution engine 1020. This task ID serves as the identifier for the executed task, allowing the task generation engine 1016 to link the database task with the unique transaction ID representing the task request from the task intelligence component 1014, and subsequently store this relationship in generative artificial intelligence-related database 1006, for example, to track the task progress. Additionally, the task generation engine 1016 can also pass the task ID and task status back to the task intelligence component 1014, and thereafter to a task handler (e.g., element 112 in FIG. 1) for data storage in one or more domain-specific task-related data structures (e.g., element 107 in FIG. 1), which facilitates continuous enhancement on the quality and contextual relevance of generative artificial intelligence-based task controller responses.

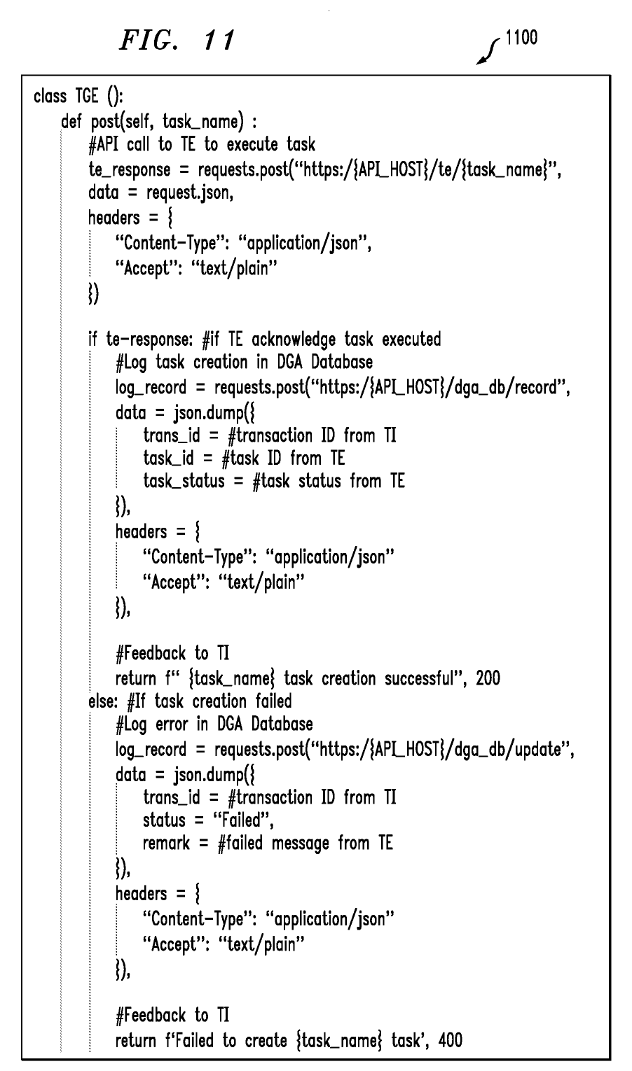

FIG. 11 shows example pseudocode for implementing a task generation engine workflow in an illustrative embodiment. In this embodiment, example pseudocode 1100 is executed by or under the control of at least one processing system and/or device. For example, the example pseudocode 1100 may be viewed as comprising a portion of a software implementation of at least part of generative artificial intelligence-based task controller 105 of the FIG. 1 embodiment.

The example pseudocode 1100 illustrates a task execution engine (TE) obtaining and/or processing the assigned task from a task generation engine (TGE), executing the assigned task (e.g., provision a new database, patching, database decommission, etc.), monitoring the progress of the task, logging task-related details in a database-related generative artificial intelligence (DGA) database (e.g., database 106 in FIG. 1), and providing feedback to user in connection with a task intelligence (TI) component. Additionally, APIs exposed by a DBMS that can be used by generative artificial intelligence-based task controller in connection with example pseudocode 1100 can include, for example, /te/notification/subscribe/task/task_id, to subscript a particular task on the DBMS; /te/notification/unsubscribe/task/task_id, to unsubscribe a particular task on the DBMS; /te/provision/task_id/{parameters}, to provision new database parameters; /te/provision/task_id/get, to get the database details; /te/decommission/task_id/{parameters}, to decommission database parameters; and /te/decommission/task_id/get, to get the decommission database details.

It is to be appreciated that this particular example pseudocode shows just one example implementation of a task generation engine workflow, and alternative implementations can be used in other embodiments.

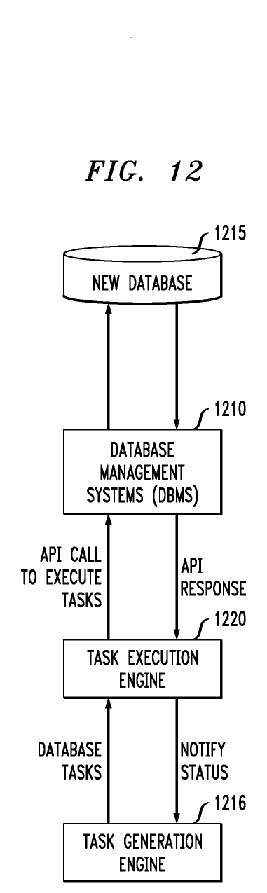

FIG. 12 shows an example workflow involving a task execution engine and a task generation engine in an illustrative embodiment. By way of illustration, FIG. 12 depicts an example workflow between task execution engine 1220 and task generation engine 1216 for provisioning a new database 1215. Additionally, when the new database 1215 is provisioned successfully, DBMS 1210 triggers a callback to task execution engine 1220 via an HTTP API in the task execution engine 1220 to notify that a new database 1215 has been created and is ready for use. Accordingly, task execution engine 1220 processes and/or receives the notification and starts calling the task generation engine 1216 to execute the relevance process of a new database creation. If the provisioning task failed, task execution engine 1220 will receive and/or process the feedback, monitoring and/or logging alert from DBMS 1210. The task execution engine 1220 implements and provides an API call along with the failed job failed details to task generation engine 1216, and task generation engine 1216 will notify the task handler (e.g., element 112 in FIG. 1) of the failure at the same time.

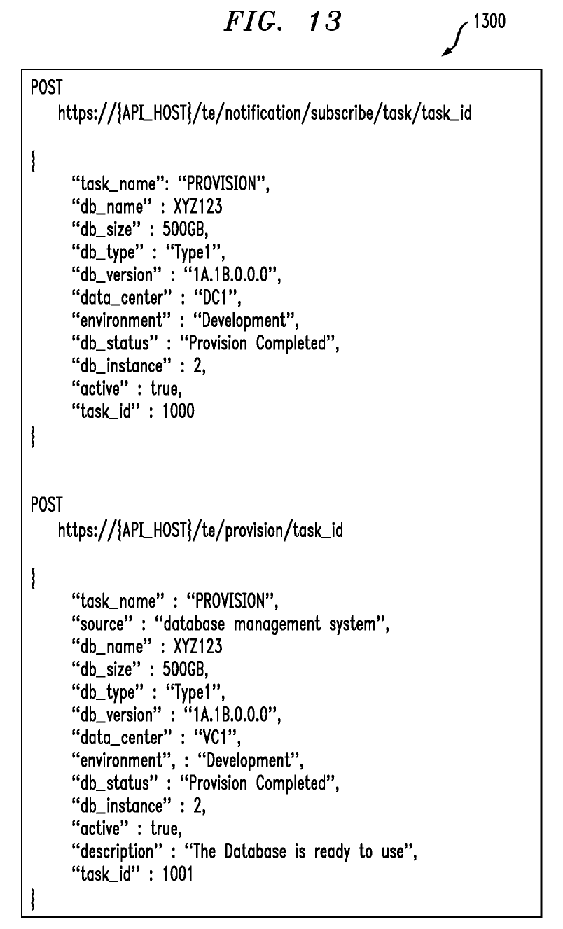

Overall, and as further detailed in connection with FIG. 13, the task execution engine 1220 acts as an interface between the task generation engine 1216 and DBMS 1210 to facilitate the process on how the provision task events are triggered and communicated.

FIG. 13 shows example pseudocode for implementing JSON data used in connection with a task execution engine in an illustrative embodiment. In this embodiment, example pseudocode 1300 is executed by or under the control of at least one processing system and/or device. For example, the example pseudocode 1300 may be viewed as comprising a portion of a software implementation of at least part of generative artificial intelligence-based task controller 105 of the FIG. 1 embodiment.

The example pseudocode 1300 illustrates JSON data for two illustrative POST APIs that are being used in the following scenarios. The first API call depicted in example pseudocode 1300 allows other software components in the generative artificial intelligence-based task controller to subscript task events. The second API call in example pseudocode 1300 allows other software components to call the task execution engine to notify the task execution engine that the provisioning task has been completed.

It is to be appreciated that this particular example pseudocode shows just one example implementation of JSON data used in connection with a task execution engine, and alternative implementations can be used in other embodiments.

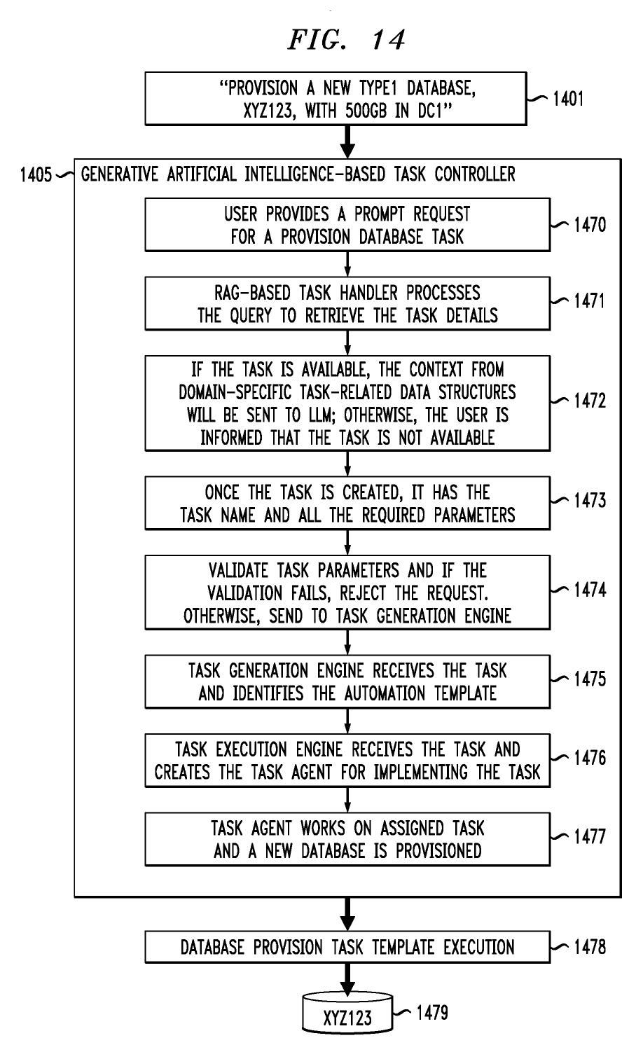

FIG. 14 shows example input, output, and a corresponding generative artificial intelligence-based task controller workflow in an illustrative embodiment. By way of illustration, FIG. 14 depicts an example input 1401 which includes a user prompt query from a database engineer that requests “Provision a new Type1 database, XYZ123, with 500GB in DC1.” Additionally, the workflow logic depicted in FIG. 14 shows various tasks involved in generating output 1478, which represents an executed task (namely, a database provisioning task template execution) and a newly provisioned database 1479 (named XYZ123) based on the task request (e.g., input 1401) from the database engineer.

More particularly, the generative artificial intelligence-based task controller 1405 workflow includes a user providing a prompt and/or request for a database provisioning task in step 1470. Also, step 1471 includes a task handler processing the query to retrieve one or more task details, and in step 1472, if the task is available, context from domain-specific task-related data structures will be sent to an LLM; otherwise, the user is informed that the task is unavailable. In step 1473, once the task is created, the task has a task name and all required task parameters.

Additionally, in step 1474, task parameter validation is performed, and if the validation fails, the request is rejected; otherwise, the task is sent to a task generation engine. In step 1475, the task validation engine receives the task and identifies a corresponding task automation template. In step 1476, a task execution engine receives the task and creates the task agent for implementing the task. Further, in step 1477, the task agent executes the task via database provision task template execution (e.g., output 1478), resulting in the provisioning of a new database 1479.

FIG. 15 is a flow diagram of a process for automated task generation and execution using artificial intelligence-based data structure processing in an illustrative embodiment. It is to be understood that this particular process is only an example, and additional or alternative processes can be carried out in other embodiments.

In this embodiment, the process includes steps 1500 through 1508. These steps are assumed to be performed by the generative artificial intelligence-based task controller 105 utilizing elements 112, 114, 116, 118 and/or 120.

Step 1500 includes obtaining a user query related to executing at least one system task in connection with one or more user-provided system task parameters. Step 1502 includes determining contextual information pertaining to the at least one system task by processing at least portions of one or more task-related data structures using a set of one or more artificial intelligence techniques. Also, the term “processing at least portions of one or more task-related data structures,” as used herein, is intended to be broadly construed, so as to encompass, for example, processing data of the one or more task-related data structures or other portions of one or more task-related data structures.

In at least one embodiment, determining contextual information pertaining to the at least one system task includes processing at least portions of the one or more task-related data structures using one or more RAG techniques in connection with one or more keywords derived from the user query. Additionally or alternatively, determining contextual information pertaining to the at least one system task can include determining at least one set of required system task parameters associated with the at least one system task by processing historical task-related data within the one or more task-related data structures using the set of one or more artificial intelligence techniques.

Step 1504 includes validating the one or more user-provided system task parameters by processing the user query and at least a portion of the determined contextual information. In one or more embodiments, validating the one or more user-provided system task parameters includes comparing the one or more user-provided system task parameters and the at least one set of required system task parameters using automated validation logic.

Step 1506 includes generating instructions for executing the at least one system task based at least in part on the validating of the one or more user-provided system task parameters. In at least one embodiment, generating instructions for executing the at least one system task includes selecting at least one automation template for executing at least a portion of the at least one system task.

Step 1508 includes initiating automated execution of the at least one system task based at least in part on the generated instructions. In one or more embodiments, initiating automated execution of the at least one system task includes transmitting the generated instructions to system management software, related to the at least one system task, for execution.

In at least one embodiment, the techniques depicted in FIG. 15 can also include generating, using at least one large language model, at least one response to the user query, requesting user confirmation of the at least one system task, the one or more user-provided system task parameters, and at least a portion of the determined contextual information.

Additionally or alternatively, the techniques depicted in FIG. 15 can include performing one or more automated actions based at least in part on initiating automated execution of the at least one system task. In such an embodiment, performing one or more automated actions can include uploading information pertaining to the automated execution of the at least one system task to the one or more task-related data structures to facilitate user monitoring of the status of the automated execution of the at least one system task. Also, in such an embodiment, performing one or more automated actions can include training the set of one or more artificial intelligence techniques using feedback related to initiating automated execution of the at least one system task.

Accordingly, the particular processing operations and other functionality described in conjunction with the flow diagram of FIG. 15 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically create enhanced task execution instructions and automatically initiate execution of the corresponding task. These and other embodiments can effectively overcome problems associated with error-prone and resource-intensive manual efforts which contribute to latencies.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

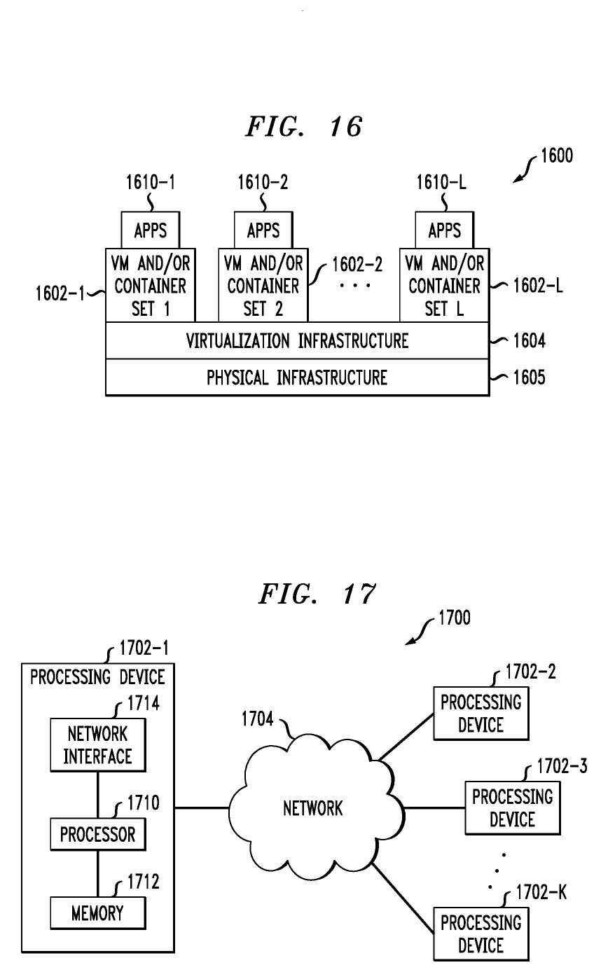

Illustrative embodiments of processing platforms will now be described in greater detail with reference to FIGS. 16 and 17. Although described in the context of system 100, these platforms may also be used to implement at least portions of other information processing systems in other embodiments.

FIG. 16 shows an example processing platform comprising cloud infrastructure 1600. The cloud infrastructure 1600 comprises a combination of physical and virtual processing resources that are utilized to implement at least a portion of the information processing system 100. The cloud infrastructure 1600 comprises multiple virtual machines (VMs) and/or container sets 1602-1, 1602-2, . . . 1602-L implemented using virtualization infrastructure 1604. The virtualization infrastructure 1604 runs on physical infrastructure 1605, and illustratively comprises one or more hypervisors and/or operating system level virtualization infrastructure. The operating system level virtualization infrastructure illustratively comprises kernel control groups of a Linux operating system or other type of operating system.

The cloud infrastructure 1600 further comprises sets of applications 1610-1, 1610-2, . . . 1610-L running on respective ones of the VMs/container sets 1602-1, 1602-2, . . . 1602-L under the control of the virtualization infrastructure 1604. The VMs/container sets 1602 comprise respective VMs, respective sets of one or more containers, or respective sets of one or more containers running in VMs. In some implementations of the FIG. 16 embodiment, the VMs/container sets 1602 comprise respective VMs implemented using virtualization infrastructure 1604 that comprises at least one hypervisor.

A hypervisor platform may be used to implement a hypervisor within the virtualization infrastructure 1604, wherein the hypervisor platform has an associated virtual infrastructure management system. The underlying physical machines comprise one or more information processing platforms that include one or more storage systems.

In other implementations of the FIG. 16 embodiment, the VMs/container sets 1602 comprise respective containers implemented using virtualization infrastructure 1604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1600 shown in FIG. 16 may represent at least a portion of one processing platform. Another example of such a processing platform is processing platform 1700 shown in FIG. 17.

The processing platform 1700 in this embodiment comprises a portion of system 100 and includes a plurality of processing devices, denoted 1702-1, 1702-2, 1702-3, . . . 1702-K, which communicate with one another over a network 1704.

The network 1704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1702-1 in the processing platform 1700 comprises a processor 1710 coupled to a memory 1712.

The processor 1710 comprises a microprocessor, a CPU, a GPU, a TPU, a microcontroller, an ASIC, a FPGA or other type of processing circuitry, as well as portions or combinations of such circuitry elements.

The memory 1712 comprises RAM, ROM or other types of memory, in any combination. The memory 1712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1702-1 is network interface circuitry 1714, which is used to interface the processing device with the network 1704 and other system components, and may comprise conventional transceivers.

The other processing devices 1702 of the processing platform 1700 are assumed to be configured in a manner similar to that shown for processing device 1702-1 in the figure.

Again, the particular processing platform 1700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining a user query related to executing at least one system task in connection with one or more user-provided system task parameters;
determining contextual information pertaining to the at least one system task by processing at least portions of one or more task-related data structures using a set of one or more artificial intelligence techniques;
validating the one or more user-provided system task parameters by processing the user query and at least a portion of the determined contextual information;
generating instructions for executing the at least one system task based at least in part on the validating of the one or more user-provided system task parameters; and
initiating automated execution of the at least one system task based at least in part on the generated instructions;
wherein the method is performed by at least one processing device comprising a processor coupled to a memory.

2. The computer-implemented method of claim 1, wherein determining contextual information pertaining to the at least one system task comprises processing at least portions of the one or more task-related data structures using one or more retrieval-augmented generation (RAG) techniques in connection with one or more keywords derived from the user query.

3. The computer-implemented method of claim 1, wherein determining contextual information pertaining to the at least one system task comprises determining at least one set of required system task parameters associated with the at least one system task by processing historical task-related data within the one or more task-related data structures using the set of one or more artificial intelligence techniques.

4. The computer-implemented method of claim 3, wherein validating the one or more user-provided system task parameters comprises comparing the one or more user-provided system task parameters and the at least one set of required system task parameters using automated validation logic.

5. The computer-implemented method of claim 1, wherein initiating automated execution of the at least one system task comprises transmitting the generated instructions to system management software, related to the at least one system task, for execution.

6. The computer-implemented method of claim 1, further comprising:
generating, using at least one large language model, at least one response to the user query, requesting user confirmation of the at least one system task, the one or more user-provided system task parameters, and at least a portion of the determined contextual information.

7. The computer-implemented method of claim 1, wherein generating instructions for executing the at least one system task comprises selecting at least one automation template for executing at least a portion of the at least one system task.

8. The computer-implemented method of claim 1, further comprising:
performing one or more automated actions based at least in part on initiating automated execution of the at least one system task.

9. The computer-implemented method of claim 8, wherein performing one or more automated actions comprises uploading information pertaining to the automated execution of the at least one system task to the one or more task-related data structures to facilitate user monitoring of the status of the automated execution of the at least one system task.

10. The computer-implemented method of claim 8, wherein performing one or more automated actions comprises training the set of one or more artificial intelligence techniques using feedback related to initiating automated execution of the at least one system task.

11. A non-transitory processor-readable storage medium having stored therein program code of one or more software programs, wherein the program code when executed by at least one processing device causes the at least one processing device:
to obtain a user query related to executing at least one system task in connection with one or more user-provided system task parameters;
to determine contextual information pertaining to the at least one system task by processing at least portions of one or more task-related data structures using a set of one or more artificial intelligence techniques;
to validate the one or more user-provided system task parameters by processing the user query and at least a portion of the determined contextual information;
to generate instructions for executing the at least one system task based at least in part on the validating of the one or more user-provided system task parameters; and
to initiate automated execution of the at least one system task based at least in part on the generated instructions.

12. The non-transitory processor-readable storage medium of claim 11, wherein determining contextual information pertaining to the at least one system task comprises processing at least portions of the one or more task-related data structures using one or more retrieval-augmented generation (RAG) techniques in connection with one or more keywords derived from the user query.

13. The non-transitory processor-readable storage medium of claim 11, wherein determining contextual information pertaining to the at least one system task comprises determining at least one set of required system task parameters associated with the at least one system task by processing historical task-related data within the one or more task-related data structures using the set of one or more artificial intelligence techniques.

14. The non-transitory processor-readable storage medium of claim 13, wherein validating the one or more user-provided system task parameters comprises comparing the one or more user-provided system task parameters and the at least one set of required system task parameters using automated validation logic.

15. The non-transitory processor-readable storage medium of claim 11, wherein initiating automated execution of the at least one system task comprises transmitting the generated instructions to system management software, related to the at least one system task, for execution.

16. An apparatus comprising:
at least one processing device comprising a processor coupled to a memory;
the at least one processing device being configured:
to obtain a user query related to executing at least one system task in connection with one or more user-provided system task parameters;
to determine contextual information pertaining to the at least one system task by processing at least portions of one or more task-related data structures using a set of one or more artificial intelligence techniques;
to validate the one or more user-provided system task parameters by processing the user query and at least a portion of the determined contextual information;
to generate instructions for executing the at least one system task based at least in part on the validating of the one or more user-provided system task parameters; and
to initiate automated execution of the at least one system task based at least in part on the generated instructions.

17. The apparatus of claim 16, wherein determining contextual information pertaining to the at least one system task comprises processing at least portions of the one or more task-related data structures using one or more retrieval-augmented generation (RAG) techniques in connection with one or more keywords derived from the user query.

18. The apparatus of claim 16, wherein determining contextual information pertaining to the at least one system task comprises determining at least one set of required system task parameters associated with the at least one system task by processing historical task-related data within the one or more task-related data structures using the set of one or more artificial intelligence techniques.

19. The apparatus of claim 18, wherein validating the one or more user-provided system task parameters comprises comparing the one or more user-provided system task parameters and the at least one set of required system task parameters using automated validation logic.

20. The apparatus of claim 16, wherein initiating automated execution of the at least one system task comprises transmitting the generated instructions to system management software, related to the at least one system task, for execution.
